(19) United States
(12) Patent Application Publication
(10) Pub. No.: US 2024/0270093 A1
(43) Pub. Date: Aug. 15, 2024

(54) Charging Station for Electric Vehicles

(71) Applicant: Siemens Aktiengesellschaft, München (DE)

(72) Inventors: Monika Poebl, München (DE); Manuel Blum, Ottobrunn (DE); Matthias de Vigneux, München (DE)

(73) Assignee: Siemens Aktiengesellschaft, München (DE)

(21) Appl. No.: 18/568,359

(22) PCT Filed: May 10, 2022
(86) PCT No.: PCT/EP2022/062563

§ 371 Date: Dec. 8, 2023

(30) Foreign Application Priority Data
Jun. 9, 2021 (DE) 10 2021 205 817.5

(51) Int. Cl. B60L 53/122; B60L 53/62

(52) U.S. Cl. CPC B60L 53/122; B60L 53/62; B60L 2210/42

(57) ABSTRACT

Various embodiments of the teachings herein include a charging station for an electric vehicle. An example charging station may include: a connection for an electrical energy source; a control device; an inverter; and an electronic coil connected to the inverter via a compensation circuit having a variable inductive device to wirelessly couple energy to the electric vehicle. The inverter applies an AC voltage to the electronic coil. The variable inductive device comprises a first winding arranged on a magnetic core and connected into the current path of the AC voltage. The variable inductive element comprises a second winding arranged on a second magnetic core in an air gap of the magnetic core. The second winding is connected to an auxiliary power supply to supply an auxiliary voltage having a DC component to the second winding.

### CROSS-REFERENCE TO RELATED APPLICATIONS

This application is a U.S. National Stage Application of International Application No. PCT/EP2022/062563 filed May 10, 2022, which designates the United States of America, and claims priority to DE Application No. 10 2021 205 817.5 filed Jun. 9, 2021, the contents of which are hereby incorporated by reference in their entirety.

### TECHNICAL FIELD

The present disclosure relates to electric vehicles. Various embodiments of the teachings herein may include charging stations and/or methods for inductively charging an electrically drivable vehicle.

### BACKGROUND

Charging stations for inductively charging an electrically drivable vehicle are used to supply energy to an electrically drivable vehicle during a charging operation in order to thus charge the energy store thereof, commonly referred to as the battery. In this case, energy is coupled wirelessly by the inductive coupling of two electronic coils, one of which is associated with the charging station and the other of which is part of the vehicle. For this purpose, the charging station is connected to an electrical energy source, for example to the public energy supply grid, to an electrical generator, to a battery or the like. The charging station generates an alternating magnetic field upon receiving electrical energy from the energy source. The electrically drivable vehicle uses its electronic coil to detect the alternating magnetic field, therefrom and provides the vehicle with electrical energy. Such arrangements are known, for example, from KR 10 2012 0016521 A.

The properties of the transformer formed from the two electronic coils are strongly influenced by the distance between the electronic coils and by the horizontal offset that is present. In an inductive charging station, these properties are variable since the parked car contains the secondary coil and it is not possible to precisely define the parking location and also the distance between the secondary coil and the ground. Among other things, this influences the resonant frequency of the primary-side circuit, that is to say the circuit on the charging-station side. However, varying the operating frequency is heavily restricted by normative specifications. US 2010/026747 A1 discloses using compensation circuits to compensate for the mentioned influences and ultimately to keep the frequency constant. These compensation circuits comprise variable devices, for example variable capacitors and/or variable inductors.

Variable inductance in the sense of a change in the inductance value seen over the period average can be achieved, for example, by means of a type of phase gating control, as known from U.S. Pat. No. 9,755,576 B2. However, this requires a controllable, bidirectionally blocking element in the operating-current path. This element then has to be designed for both the voltage that occurs, which is often more than 1 kV, and for the current. Another possibility lies in using clever dimensioning to achieve partial saturation of desired constrictions in the magnetic circuit by way of the operating current. Although this too leads to a change in the inductance value, it cannot be controlled independently of the operating current.

### SUMMARY

The teachings of the present disclosure include inductive charging stations having a compensation circuit containing a variable-inductance device, which inductive charging station is used to avoid the disadvantages mentioned above. For example, some embodiments include a charging station (10) for an electric vehicle, having a connection for an electrical energy source (14), a control device, an inverter (11) and an electronic coil (20), which is connected to the inverter (11), for the purpose of wirelessly coupling energy to the electrically drivable vehicle, wherein the inverter (11) is set up to apply an AC voltage to the electronic coil (20), the electronic coil (20) is connected to the inverter (11) via a compensation circuit having a variable inductive device (L1, L2), the variable inductive device (L1, L2) comprises a winding (33) arranged on a magnetic core (31) and connected into the current path of the AC voltage, the variable inductive element (L1, L2) comprises a second winding (36) arranged on a second magnetic core (35) in the air gap (32) of the magnetic core (31), and the second winding (36) is connected to an auxiliary power supply which is configured to supply an auxiliary voltage having a DC component to the second winding (36).

In some embodiments, the control device is configured to keep the frequency of the AC voltage within a frequency band, in particular to keep the frequency constant.

In some embodiments, the control device is configured to maximize the inductively transmitted power and/or the efficiency of the inductive transmission by varying the auxiliary voltage.

In some embodiments, the auxiliary voltage is a DC voltage.

In some embodiments, the magnetic core (31) is a ferrite core.

In some embodiments, the second magnetic core (35) comprises a material which has a higher saturation flux density than the material of the magnetic core (31).

In some embodiments, the magnetic core (31) is an EE core.

In some embodiments, the second magnetic core (35) is arranged in the air gap (32) of the central E arm.

In some embodiments, the second magnetic core (35) is an EE core.

As another example, some embodiments include a method for operating a charging station (10) for an electrically drivable vehicle, in which the charging station (10) draws electrical energy from an electrical energy source (14) and uses an inverter (11) and an electronic coil (20), which is connected to the inverter (11) via a compensation circuit, to produce an AC voltage, the electronic coil (20) using said AC voltage to provide an alternating magnetic field for the purpose of wirelessly coupling energy to the electrically drivable vehicle, and the inductance of a variable inductive device (L1, L2) of the compensation circuit is varied by applying an auxiliary voltage, wherein the auxiliary voltage has a DC component.

### BRIEF DESCRIPTION OF THE DRAWINGS

Further advantages and features can be taken from the following description of exemplary embodiments based on the figures. In the figures, identical reference signs denote identical parts and functions. In the figures:

FIG. 1 shows a schematized circuit diagram of a charging station which uses a magnetic field to wirelessly couple energy to a matching receiving circuit of an electrically drivable vehicle during a charging operation;

FIG. 2 shows a variable-inductance device; and

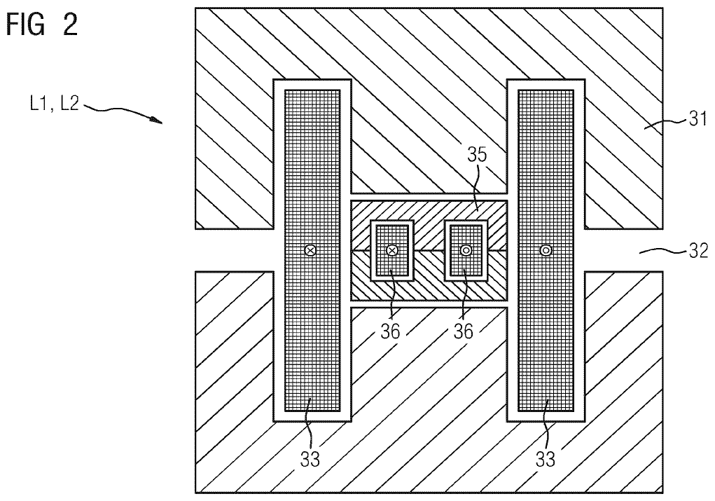

FIG. 3 shows a detail from a B-H graph for a ferrite material.

### DETAILED DESCRIPTION

In some embodiments of the teachings herein, a charging station for an electrically drivable vehicle comprises a connection for an electrical energy source, a control device, an inverter and an electronic coil, which is connected to the inverter, for the purpose of wirelessly coupling energy to the electrically drivable vehicle. The inverter is set up to apply an AC voltage to the electronic coil. The electronic coil is in turn connected to the inverter via a compensation circuit, wherein the compensation circuit has a variable inductive device.

The variable inductive device comprises a winding arranged on a magnetic core and connected into the current path of the AC voltage. Furthermore, it comprises a second winding arranged on a second magnetic core in the air gap of the magnetic core. In this case, the second winding is connected to an auxiliary power supply which is configured to supply an auxiliary voltage having a DC component to the second winding.

In some embodiments, there is a method for operating a charging station for an electric vehicle. The charging station draws electrical energy from an electrical energy source and uses an inverter and an electronic coil, which is connected to the inverter via a compensation circuit, to produce an AC voltage, the electronic coil using said AC voltage to provide an alternating magnetic field for the purpose of wirelessly coupling energy to the electrically drivable vehicle. In this case, the inductance of a variable inductive device of the compensation circuit is varied by applying an auxiliary voltage, wherein the auxiliary voltage has a DC component.

A variable inductive element can be provided by partially saturating the magnetic circuit. However, the partial saturation here is not caused by the operating current itself, that is to say the flow of current in the winding produced by the AC voltage, but by a separately variable DC premagnetization of a small part of the magnetic circuit. This premagnetization is made possible by inserting the second winding in the air gap region. A current which has a DC component and is expediently a pure DC current is applied to the second winding in order to achieve a DC bias for the flux in the core.

This DC bias leads to the starting point of the AC flow being repositioned locally in the saturation range on the B-H curve of the material, for example ferrite N87. The resultant local effect is a different flux density, which in turn locally causes a different permeability and thus reduces the overall inductance. It is also possible to use the magnitude of the DC bias to vary the gradient (permeability) and thus inductance in a certain range.

Compared with known configurations of a variable inductor, the embodiments described herein have no need for a controllable, bidirectionally blocking element designed for high voltages in the operating-current path for changing the inductance. This leads to a reduction in the necessary use of hardware and in losses. Furthermore, the decoupling of saturation and operating current makes it possible to regulate the inductance value in a manner independent of the operating point. As a result, improved control and regulation is achieved on the whole, thanks to which the normative specifications regarding the operating frequency during inductive charging are met.

In some embodiments, the following features can also be additionally provided for the charging station:

The control device can be configured to keep the frequency of the AC voltage within a frequency band, in particular to keep the frequency constant. This may be required in particular due to normative specifications.

The control device can be configured to maximize the inductively transmitted and/or the efficiency of the inductive transmission by varying the auxiliary voltage. For this purpose, the applied auxiliary voltage can be iteratively raised or lowered for example at the start of a charging process until a maximum efficiency or a maximum transmitted power is reached or the adjustment range of the auxiliary voltage is used up.

The auxiliary voltage can be a DC voltage, that is to say it has no intentional AC component. This allows the best prediction of what change in the inductance will arise. An AC component of the auxiliary voltage is undesirable.

The magnetic core can be a ferrite core and can for example be designed as an EE core. The second magnetic core may be arranged in the air gap of the central E arm. It can for example fill this air gap. The second magnetic core can likewise be embodied as an EE core. An EE core, in this disclosure, refers to the physical shape of the core.

In some embodiments, the second magnetic core comprises a material which has a higher saturation flux density than the material of the magnetic core. In particular, the second magnetic core can consist of this material. For example, the second magnetic core can consist of a nanocrystalline material such as kOr 120, for example. In the case of such materials, a considerably higher flux density is necessary to cause a change in permeability. The operating current can have a significantly higher AC modulation without producing a considerable change in permeability in the second magnetic core. As a result, it is possible to design the magnetic circuit in a more efficient manner on the whole and thus to save costs and material. In addition, a higher adjustment range for the inductance value can be expected.

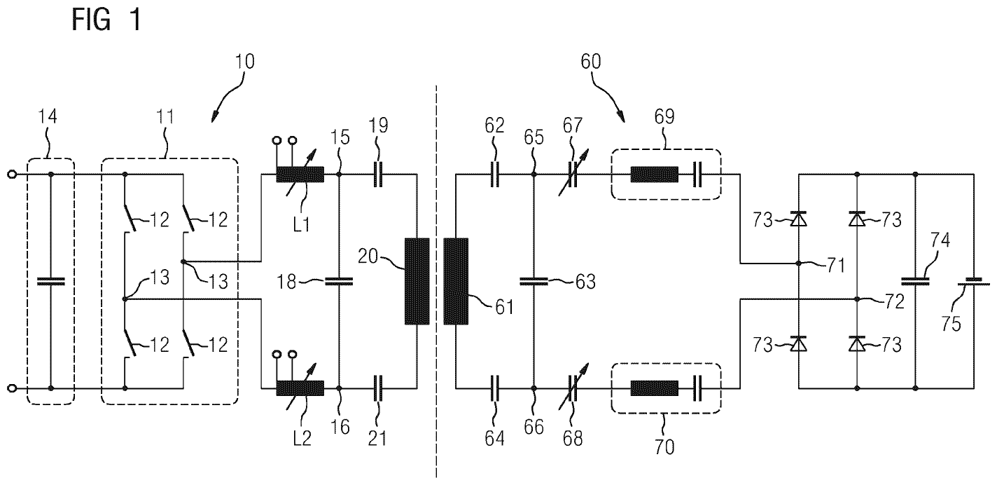

FIG. 1 shows a charging station 10 incorporating teachings of the present disclosure for electrically charging an electrically operated vehicle. FIG. 1 further shows an exemplary receiving circuit 60 which is part of such a vehicle and is inductively coupled to the charging station 10.

In this case, the charging station 10 comprises an inverter 11, the input side of which is connected to a DC voltage source, for example a DC link circuit 14. The DC voltage source can for its part be supplied with power from the supply network, for example, a connection to a local grid or else to a medium-voltage source being possible.

The inverter 11 comprises a full bridge having four power semiconductor switches 12. In this case, two of the switches 12 form a series connection in each case and the two series connections are for their part connected in parallel. The outputs 13 of the inverter 11 are formed by the potential points between the switches 12 connected in series.

A first of the outputs 13 is connected to a first node 15 via a first variable inductive device L1. The second of the outputs 13 is connected to a second node 16 via a second variable inductive device L2. A first capacitive device 18 is connected between the first and second nodes 15, 16. A series connection comprising a second capacitive device 19, a coil 20 and a third capacitive device 21 is connected in parallel with the first capacitive device 18.

The coil 20 produces the inductive coupling to a coil 61 on the vehicle, provided that such a coil is present, that is to say provided that a vehicle is parked in the region of the charging station. The coil 61 on the vehicle is connected in series with a fourth, fifth and sixth capacitive device 62, 63, 64. A third node 65 is formed between the fourth and fifth capacitive devices 62, 63 and a fourth node 66 is formed between the fifth and sixth capacitive devices 63, 64. The capacitive devices 62, 63, 64 can be individual capacitors or else networks of a plurality of capacitors.

The third and fourth nodes 65, 66 are each connected to a fifth and sixth node 71, 72, respectively, via a variable capacitor 67, 68 and an LC filter 69, 70. The fifth and sixth nodes 71, 72 form the input points of a—in this case passive—rectifier having four diodes 73 connected together in a known way. The output side of the rectifier is connected to a smoothing capacitor 74 and the accumulator of the vehicle 75.

As a whole, the charging system composed of the charging station 10 and the receiving circuit 60 thus forms a DC-DC converter structure having electrical isolation, the properties of the transformer composed of the two coils 20, 61 being able to vary widely due to the parking position of the vehicle and its structural properties.

Normative specifications call for a control apparatus, not depicted in FIG. 1, to actuate the power semiconductor switches 12 at a substantially constant frequency in this example. Varying the efficiency of the inductive transmission by changing the frequency is therefore excluded in this example. An optimal point on the transmission function is therefore selected here using the variable inductive devices L1, L2.

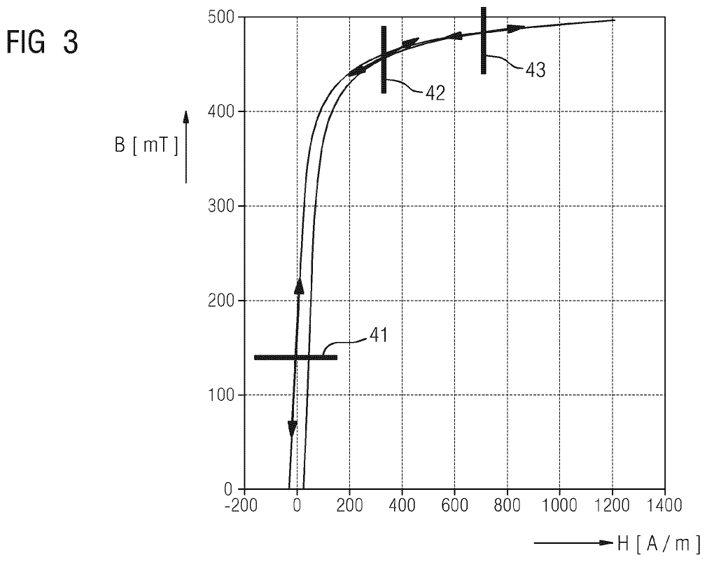

The design of the variable inductive devices L1, L2 is depicted schematically in FIG. 3. The variable inductive device L1, L2 is based on a first magnetic core 31 having an air gap 32. The first magnetic core 31 is configured as an EE core and bears the main winding 33 around the middle arms 311. The main winding 33 is connected into the current path of the AC current, as can be seen in FIG. 1. A second magnetic core 35 is arranged in the air gap 32 in the region of the middle arms 311. The second magnetic core 35 is likewise an EE core, the size of which matches the size of the air gap 32 so that it fits therein. In this case, the second magnetic core 35 preferably has no air gap and largely fills the air gap 32 in the region of the middle arms 311 of the first magnetic core 31. The middle arms 351 of the second magnetic core 35 bear an auxiliary winding 36. The orientation of the turns of the auxiliary winding 36 is depicted as in the same direction as the main winding 33 in FIG. 3 but can be chosen arbitrarily.

The auxiliary winding 36 is not connected into the current path of the AC current but rather is connected to an auxiliary voltage source which delivers a DC voltage. The amplitude of the DC voltage can be varied. The auxiliary voltage source can for example be a DC-DC converter which is connected to a low-voltage source that is present elsewhere. The auxiliary voltage can be used to predefine a DC bias for the auxiliary winding 36. This DC bias leads to the starting point of the AC flow of the operating current being repositioned locally in the saturation range on the B-H curve of the material of the second magnetic core 35. The local effect there is now a different flux density, which in turn locally causes a different permeability and thus reduces the overall inductance. It is also possible to use the magnitude of the DC bias to vary the gradient (permeability) and thus the arising inductance in a certain range. In this case, it is advantageous if the applied AC modulation is small enough not to thus also cause a significant change in permeability at certain times.

FIG. 3 shows a detail from a magnetization curve for the second magnetic core 35. In this case, different values for the DC bias 41 . . . 43 predefined by the auxiliary voltage define a particular primary magnetization. The AC current in the main winding ensures the magnetization is varied, this being indicated by arrows. Different values for the DC bias ensure different effective values of the differential permeability.

The material of the second magnetic core 35 can be chosen freely and the first and the second magnetic core 33, 35 can in particular be ferrite cores. In this embodiment, the first magnetic core 33 is a ferrite core but the second magnetic core 35 consists of nanocrystalline kOr 120. This material has a higher saturation flux density than ferrite. As a result, considerably higher flux densities than in the magnetic core 31 made of ferrite are necessary in the second magnetic core 35 in order to cause a change in permeability. This has the advantage that even high AC modulation does not then entail a large change in permeability. The DC magnetization necessary to set the desired inductance can, however, be varied in a targeted manner. As a result, the restriction to a small AC amplitude is minimized.

### LIST OF REFERENCE SIGNS

10 charging station
11 inverter
12 power semiconductor switch
13 inverter output
14 DC link circuit
15, 16 node
L1, L2 variable inductive device
18, 19, 21 capacitive devices
20, 61 coil
31 magnetic core
32 air gap
33 winding
35 second magnetic core
36 second winding
60 receiving circuit
62, 63, 64 capacitive devices
65, 66 node
67, 68 variable capacitors
69, 70 LC filter
71, 72 node
73 diode
74 smoothing capacitor
75 accumulator (vehicle battery)

What is claimed is:

1. A charging station for an electric vehicle, the charging station comprising:
a connection for an electrical energy source;
a control device;
an inverter; and
an electronic coil connected to the inverter via a compensation circuit having a variable inductive device to wirelessly couple energy to the electric vehicle;
wherein
the inverter applies an AC voltage to the electronic coil;
the variable inductive device comprises a first winding arranged on a magnetic core and connected into the current path of the AC voltage;
the variable inductive element comprises a second winding arranged on a second magnetic core in an air gap of the magnetic core;
the second winding is connected to an auxiliary power supply to supply an auxiliary voltage having a DC component to the second winding.

2. The charging station as claimed in claim 1, wherein the control device keeps the frequency of the AC voltage within a frequency band.

3. The charging station as claimed in claim 1, wherein the control device maximizes the inductively transmitted power and/or the efficiency of the inductive transmission by varying the auxiliary voltage.

4. The charging station as claimed in claim 1, wherein the auxiliary voltage is a DC voltage.

5. The charging station as claimed in claim 1, wherein the magnetic core comprises a ferrite core.

6. The charging station as claimed in claim 1, wherein the second magnetic core comprises a material with a higher saturation flux density than the magnetic core.

7. The charging station as claimed in claim 1, in which the magnetic core comprises an EE core.

8. The charging station as claimed in claim 7, in which the second magnetic core is arranged in an air gap of a central arm of one of the Es from the EE core.

9. The charging station as claimed in claim 1, wherein the second magnetic core comprises an EE core.

10. A method for operating a charging station for an electric vehicle, the method comprising:
drawing electrical energy with the charging station from an electrical energy source;
using an inverter and an electronic coil connected to the inverter via a compensation circuit to produce an AC voltage;
using the electronic coil and the AC voltage to provide an alternating magnetic field for wirelessly coupling energy to the electric vehicle; and
varying an inductance of a variable inductive device of the compensation circuit by applying an auxiliary voltage with a DC component.
